(19) United States
(12) Patent Application Publication
(10) Pub. No.: US 2026/0284569 A1
(43) Pub. Date: Sep. 24, 2026

(54) RECEPTACLE FOR A REFILLABLE DEHUMIDIFIER

(71) Applicant: GOLD TECHNIC PTE. LTD., Singapore (SG)

(72) Inventors: Ming Jie Wong, Singapore (SG); Ming Yang Wong, Singapore (SG); Seng Kwong Wong, Singapore (SG); Siok Chin Yap, Singapore (SG); Jiewei Wong, Singapore (SG)

(21) Appl. No.: 19/478,505

(22) PCT Filed: May 3, 2023
(86) PCT No.: PCT/SG2023/050300

§ 371 Date: Oct. 24, 2025

(51) Int. Cl. B01D 53/04; B01D 53/26

(52) U.S. Cl. CPC B01D 53/0407; B01D 53/261; B01D 53/268; B01D 2257/80; B01D 2259/40084

(57) ABSTRACT

A receptacle for a refillable dehumidifier comprising: a container to hold moisture absorbing beads and a liquid obtained from dissolution of the beads; a tray provided to support the beads away from a bottom of the container and having openings for the liquid to drip through; and a lid comprising: a panel having through holes, a plurality of lock flaps wherein one edge of each lock flap pivotably engages the panel and a free edge of the lock flap is configured to detachably engage an external projection provided on an exterior surface of the container and a membrane filter covering the through holes to allow water vapour to enter while preventing liquid droplets from exiting the receptacle, wherein when the lock flaps engage the external projection, the beads and any liquid in the container are prevented by the lid from exiting the receptacle when the receptacle is overturned.

### CROSS-REFERENCE TO RELATED APPLICATION

This Application is a Section 371 National Stage Application of International Application No. PCT/SG2023/050300, filed May 3, 2023 and published as WO 2024/228662 A1 on Nov. 7, 2024, in English.

### TECHNICAL FIELD

This invention relates to a receptacle for a refillable desiccant dehumidifier.

### BACKGROUND

Refillable dehumidifiers use moisture absorbing beads provided in a receptacle to remove moisture in the surrounding air. The beads dissolve into a liquid when they have absorbed enough moisture. A receptacle for refillable dehumidifiers typically comprises a plastic container for holding the moisture absorbing beads and the liquid formed therein, and also a removable lid for the container to allow the liquid to be poured away and new beads to be added to the container. The lid has through holes to allow passage of water vapour therethrough and a membrane filter covers the through holes. The membrane filter allows water vapour to enter the receptacle while preventing liquid droplets from exiting the receptacle when the lid is secured to the container. Within the container, the beads rest on a tray provided at a distance away from a bottom of the container and the liquid that is formed drips from the tray into the bottom of the container through openings provided in the tray. However, liquid and beads can spill from currently available refillable dehumidifiers if they are accidentally overturned, and the openings in the tray also often get clogged such that undissolved beads are surrounded by liquid which blocks their exposure to moisture in the air such that they are unable to absorb the moisture, thereby reducing efficacy of the dehumidifier. It is therefore desirable to provide a receptacle that prevents spilling of liquid and also minimizes clogging of the openings in the tray.

### SUMMARY

According to a first aspect, there is provided a receptacle for a refillable dehumidifier, the receptacle comprising: a container provided to hold therein moisture absorbing beads and a liquid obtained from dissolution of the moisture absorbing beads upon absorption of sufficient moisture from surrounding air; a tray configured to be provided within the container to support the moisture absorbing beads thereon at a distance away from a bottom of the container, the tray having a plurality of openings to allow the liquid to drip through the plurality of openings to the bottom of the container; and a lid provided to securably and openably cover the container, the lid comprising a panel that is sized to fully cover a top opening of the container, the panel having a plurality of through holes, the lid further comprising a plurality of lock flaps wherein for each lock flap, one edge of the lock flap pivotably engages the panel and a free edge of the lock flap is configured to detachably engage an external projection provided on an exterior surface of the container, the lid further comprising a membrane filter covering the through holes in the panel wherein the membrane filter allows water vapour to enter the receptacle through the through holes in the panel while preventing liquid droplets from exiting the receptacle, wherein when the lock flaps of the lid engage the external projection of the container, the lid is secured to the container such that the moisture absorbing beads and any liquid at the bottom of the container are prevented by the lid from exiting the receptacle when the receptacle is overturned.

The tray may comprise two adjoining plates arranged to give the tray a shallow V-shaped cross-section, wherein the plurality of openings are provided in the two adjoining plates and sized to prevent passage of the moisture absorbing beads therethrough before dissolution of the moisture absorbing beads and to allow the liquid to drip through the plurality of openings to the bottom of the container.

The plurality of openings may comprise a plurality of slots that channel the liquid via gravitational pull and capillary action towards a central part of the tray where an apex of the V-shaped cross-section is located.

An included angle α of the V-shaped cross-section may range from 150° to 160°.

Each lock flap may include a hooked protrusion provided at the free edge of the lock flap, wherein the hooked protrusion is configured to snap onto the external projection in a cantilever snap configuration when the panel is placed over the top opening of the container and the lock flap is pressed towards the container.

The lid may further comprise two rims provided around a periphery of the panel, the two rims projecting downwardly from an underside of the lid to define a channel between the two rims within which a silicon gasket is provided, wherein the liquid proof seal is formed between the silicon gasket and the container when the lock flaps engage the external projection of the container.

The present summary is provided only by way of example and not limitation. Other aspects of the present invention will be appreciated in view of the entirety of the present disclosure, including the entire text, claims, and accompanying figures.

### BRIEF DESCRIPTION OF DRAWINGS

In order that the invention may be fully understood and readily put into practical effect there shall now be described by way of non-limitative example only exemplary embodiments of the present invention, the description being with reference to the accompanying illustrative drawings, in which:

FIG. 1 is an isometric view of an exemplary receptacle of a refillable dehumidifier.

FIG. 2A is an isometric view of the receptacle of FIG. 1 with its lid removed.

FIG. 2B is an isometric view of a container of the receptacle of FIG. 1.

FIG. 3 is an isometric top view of a lid of the receptacle of FIG. 1.

FIG. 4 is a front elevation view of the lid of FIG. 3.

FIG. 5 is an isometric bottom view of the lid of FIG. 3.

FIG. 6 is a front elevation view of the receptacle of FIG. 1.

FIG. 7 is an isometric view of a tray of the receptacle of FIG. 2A.

FIG. 8 is a plan view of the tray of FIG. 7.

FIG. 9 is a front elevation view of the tray of FIG. 7.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF THE EMBODIMENTS

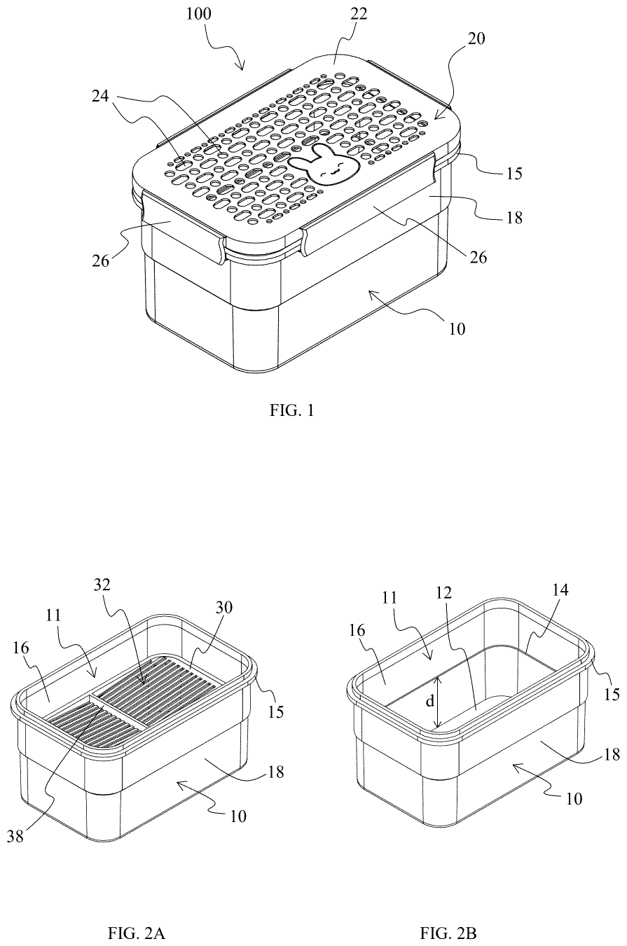

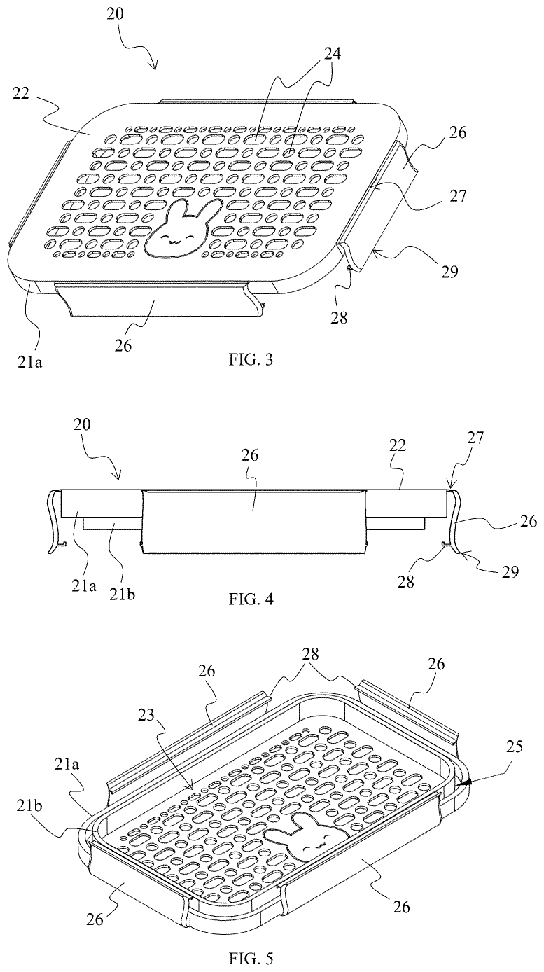

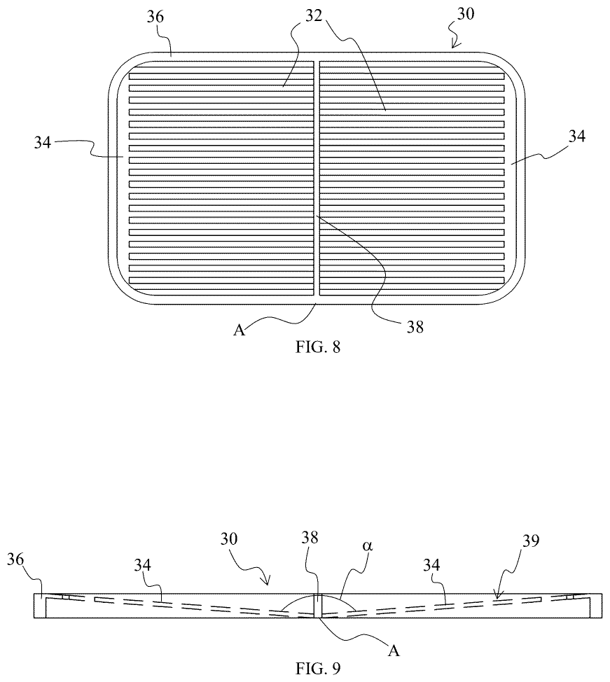

Exemplary embodiments of a receptacle 100 for a refillable dehumidifier will be described below with reference to FIGS. 1 to 9.

An exemplary receptacle 100 for a refillable dehumidifier 10 comprises a plastic container 10 and a plastic lid 20 as shown in FIG. 1. The receptacle 100 further comprises a plastic tray 30 that is configured to be provided in the container 10 at a distance d away from the bottom 12 of the container 10 as shown in FIGS. 2A and 2B. The tray 30 is configured to support moisture absorbing beads (not shown) thereon within the container 10. When the moisture absorbing beads on the tray 30 have absorbed a sufficient amount of moisture, they dissolve into a liquid. The tray 30 has a plurality of openings 32 to allow the liquid to drip through the tray 30 to the bottom 12 of the container 10. The tray 30 will be described in greater detail below.

As shown in FIG. 2B, the container 10 may comprise one or more internal projections 14 provided on its inner walls 16 at the distance d away from the bottom 12 of the container for supporting the tray 30 thereon. The one or more internal projections 14 may comprise a continuous ledge 14 encircling the inside of the container 10 as shown in FIG. 2B. In an alternative embodiment (not shown), two internal projections 14 may be provided on opposite walls of the container 10 to support the tray 30 thereon.

Referring to FIGS. 1 and 3-6, the lid 20 comprises a panel 22 that is sized to fully cover a top opening 11 of the container 10 (shown in FIGS. 2A and 2B). The panel 22 has a plurality of through holes 24. Around a periphery of the panel 22 are two rims 21a, 21b that project downwardly from an underside 23 of the lid 20 to define a channel 25 between the two rims 21a, 21b. The channel 25 has a size and shape that matches a size and shape of the top opening 11 of the container 10. Within the channel 25 there is preferably provided a silicon gasket (not shown).

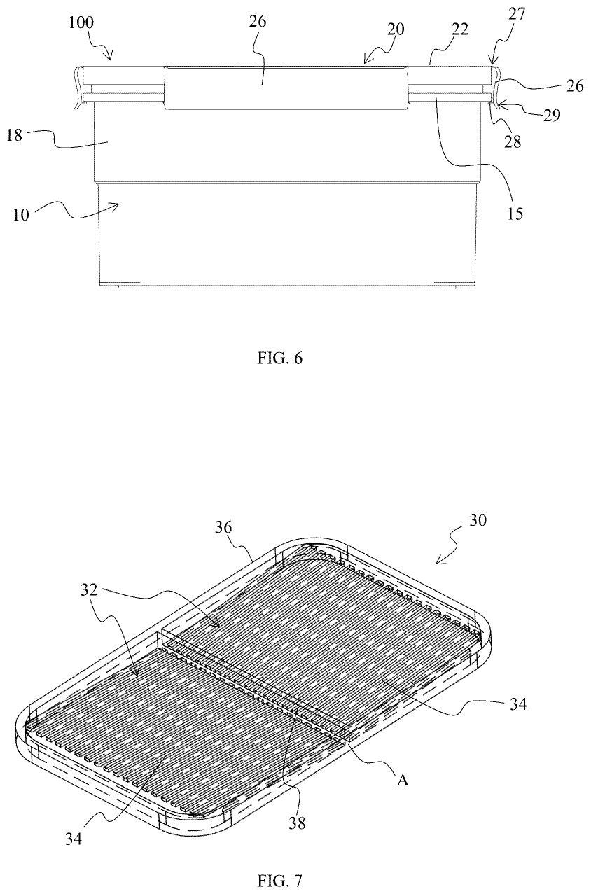

The lid 20 further comprises a plurality of lock flaps 26. For each lock flap 26, one edge 27 of the lock flap 26 pivotably engages the panel 22 and an opposite (free) edge 29 of the lock flap 26 is configured to detachably engage an external projection 15 provided on an exterior surface 18 of the container 10. The external projection 15 may comprise a single flange 15 encircling the exterior surface 18 of the container 10 as shown in FIGS. 1 and 6. Alternatively, the external projection 15, or may comprise a number of external projections (not shown) corresponding to the number of lock flaps 26.

To engage the external projection 15 on the container 10, the free edge 29 of each lock flap 26 may be provided with a hooked protrusion 28 that snaps onto the external projection 15 in a cantilever snap fit configuration when the panel 22 is placed over the top opening 11 of the container 10 and the lock flap 26 is pressed towards the container 10. When all the locked flaps 26 have been snapped onto the external projection 15, the receptacle 100 is in a secured configuration as shown in FIGS. 1 and 4 and the silicon gasket in the channel 25 of the lid 22 forms a liquid-proof seal with the container 10. In the secured configuration, pulling a lock flap 26 away from the container 10 disengages the hooked protrusion 28 from the external projection 15 to release the lid 20 from the container 10 when all the lock flaps 26 have been disengaged from the external projection 15.

The lid 20 further comprises a membrane filter (not shown) covering the through holes 24 in the panel 22. The membrane filter is preferably provided on the underside 23 of the lid 20. When the receptacle 100 is in the secured configuration, the membrane filter allows water vapour to enter the receptacle 100 through the through holes 24 in the panel 22 while preventing liquid droplets from exiting the receptacle 100. At the same time, the moisture absorbing beads and any liquid at the bottom 12 of the container 10 are prevented by the lid 20 from exiting the container 10 if and when the receptacle 100 is overturned.

Referring to FIGS. 7 to 9, the tray 30 preferably comprises two adjoining plates 34 supported by a rim 36 that engages the internal projection 12 of the container 10. In the exemplary embodiment, the two plates 34 and the rim 36 are integrally formed. The two plates 34 are arranged to give the tray 30 a shallow V-shaped cross-section 39 as can be seen in FIG. 9. The plurality of openings 32 mentioned above are provided in the two plates 34. In the exemplary embodiment, the plurality of openings 32 comprise a plurality of slots 32 that channel the liquid from dissolution of the beads via gravitational pull and capillary action towards a central part 38 of the tray 30 where an apex A of the V-shaped cross-section is located. The plurality of openings 32 are sized to prevent passage of the moisture absorbing beads therethrough before the beads are dissolved, and to allow the liquid that is formed to drip through the plurality of openings 32 to the bottom 12 of the container 10. In exemplary embodiments, the included angle α of the V-shaped cross-section may range from 150° to 160° as shown in FIG. 9. Providing the tray 30 with a V-shaped cross-section prevents liquid from pooling on the tray 30 after the beads have dissolved, thereby minimizing interference of the liquid with beads that have not yet dissolved. This in turn minimizes clogging of the openings 32 of the tray 30 while optimizing efficacy of the moisture absorbing beads by efficient draining of the liquid to maximise exposure of the remaining beads to moisture in the air.

The receptacle 100 depicted in the figures has a rounded rectangular shape when viewed from the top, i.e. in plan view. However, it will be appreciated that the receptacle 100 may have other shapes in plan view, such as circular, triangular, square, hexagonal and so on. The number of lock flaps 26 is not limited to four as shown in the figures, but may be any other number as desired. For example, when the container 10 is cylindrical and the panel 12 is circular (not shown), the lid 10 may have three or more lock flaps in hinged engagement with the panel 12. While the lock flaps 26 of the exemplary embodiment of the receptacle 100 have a rectangular shape as depicted in the figures, in alternative embodiments, the lock flaps 26 may have other shapes such as a segment of a circle, a square, a rounded tab, for example. In the exemplary embodiment, the lock flaps 26 are integral with the panel 22 and the pivotable engagement between each lock flap 26 and the panel 22 is achieved by a living hinge provided between the lock flap 26 and the panel 22. In alternative embodiments, the lock flaps 26 may be separate components that are assembled with the panel 22 to provide a pivotable engagement. In the exemplary embodiment, the plurality of openings 32 in the tray 30 are shown as parallel straights slots in the plates 34. In alternative embodiments (not shown), the openings 32 may be wavy slots or a number of alternately arranged shorter slots provided in the plates 34, for example.

Using the above-described receptacle 100 for refillable dehumidifiers, spillage of liquid and moisture absorbing beads is prevented in case the receptacle 100 is overturned as the lid 20 is securely fastened to the container 10 by means of the lock flaps 26 engaging the external projection 15. Efficacy of the dehumidifier is also improved as the above-described tray 30 of the receptacle 100 provides efficient draining of the liquid that is formed when the beads dissolve upon sufficient moisture absorption, so as to minimize clogging of the tray 30 and maximise exposure of the remaining beads to continue absorbing moisture in the air.

While there has been described in the foregoing description exemplary embodiments of the present invention, it will be understood by those skilled in the technology concerned that many variations in details of design, construction and/or operation may be made without departing from the present invention.

1. A receptacle for a refillable dehumidifier, the receptacle comprising:
a container provided to hold therein moisture absorbing beads and a liquid obtained from dissolution of the moisture absorbing beads upon absorption of sufficient moisture from surrounding air;
a tray configured to be provided within the container to support the moisture absorbing beads thereon at a distance away from a bottom of the container, the tray having a plurality of openings to allow the liquid to drip through the plurality of openings to the bottom of the container; wherein the container comprises one or more internal projections provided on inner wall of the container for supporting the tray; and
a lid provided to securably and openably cover the container, the lid comprising a panel that is sized to fully cover a top opening of the container, the panel having a plurality of through holes, the lid further comprising a plurality of lock flaps wherein for each lock flap, one edge of the lock flap pivotably engages the panel and a free edge of the lock flap is configured to detachably engage an external projection provided on an exterior surface of the container, the lid further comprising a membrane filter covering the through holes in the panel wherein the membrane filter allows water vapour to enter the receptacle through the through holes in the panel while preventing liquid droplets from exiting the receptacle,
wherein when the lock flaps of the lid engage the external projection of the container, the lid is secured to the container such that the moisture absorbing beads and any liquid at the bottom of the container are prevented by the lid from exiting the receptacle when the receptacle is overturned,
wherein the tray comprises two adjoining plates arranged to give the tray a shallow V-shaped cross-section, wherein the plurality of openings are provided in the two adjoining plates and sized to prevent passage of the moisture absorbing beads therethrough before dissolution of the moisture absorbing beads and to allow the liquid to drip through the plurality of openings to the bottom of the container, and
wherein the plurality of openings comprise a plurality of slots that channel the liquid via gravitational pull and capillary action towards a central part of the tray where an apex of the V-shaped cross-section is located.

2. (canceled)

3. (canceled)

4. The receptacle of claim 1, wherein an included angle α of the V-shaped cross-section ranges from 150° to 160°.

5. The receptacle of claim 1, wherein when the lock flaps of the lid engage the external projection of the container, the lid is secured to the container to with a liquid proof seal.

6. The receptacle of claim 5, wherein each lock flap includes a hooked protrusion provided at the free edge of the lock flap, wherein the hooked protrusion is configured to snap onto the external projection in a cantilever snap configuration when the panel is placed over the top opening of the container and the lock flap is pressed towards the container.

7. The receptacle of claim 5, wherein the lid further comprises two rims provided around a periphery of the panel, the two rims projecting downwardly from an underside of the lid to define a channel between the two rims within which a silicon gasket is provided, wherein the liquid proof seal is formed between the silicon gasket and the container when the lock flaps engage the external projection of the container.
